(19) United States
(12) Patent Application Publication
(10) Pub. No.: US 2024/0276270 A1
(43) Pub. Date: Aug. 15, 2024

(54) PRIORITIZATION OF EVENT TRIGGERED MOBILITY REPORTS

(71) Applicant: QUALCOMM Incorporated, San Diego, CA (US)

(72) Inventors: Tianyang Bai, Mountain View, CA (US); Yan Zhou, San Diego, CA (US); Jelena Damnjanovic, Del Mar, CA (US)

(21) Appl. No.: 18/502,528

(22) Filed: Nov. 6, 2023

Related U.S. Application Data
(60) Provisional application No. 63/484,869, filed on Feb. 14, 2023.

(51) Int. Cl. H04W 24/10; H04L 5/00

(52) U.S. Cl. CPC H04W 24/10; H04L 5/0048

(57) ABSTRACT

This disclosure provides systems, methods, and devices for wireless communication that support prioritization of reference signal measurement reports. In a first aspect, a UE measures a reference signal, determines that a trigger condition for transmission of a first report is met based on measurement of the reference signal, and transmits the first report on a resource on which the first report and a second report overlap based on priorities of the first report and the second report. Other aspects and features are also claimed and described.

### CROSS-REFERENCE TO RELATED APPLICATIONS

This application claims the benefit of U.S. Provisional Patent Application No. 63/484,869, entitled, “PRIORITIZATION OF EVENT TRIGGERED MOBILITY REPORTS,” filed on Feb. 14, 2023, which is expressly incorporated by reference herein in its entirety.

### TECHNICAL FIELD

Aspects of the present disclosure relate generally to wireless communication systems, and more particularly, to reporting of measurements in a wireless network. Some features may enable and provide improved communications, including prioritization of event triggered mobility reports.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes measuring a reference signal transmitted by a network node, wherein the network node is a candidate serving cell, determining that a trigger condition for transmission of a first report is satisfied based on the measurement of the reference signal, determining that a first resource for transmission of the first report overlaps with a second resource for transmission of a second report, determining a first priority of the first report and a second priority of the second report, and transmitting the first report on the first resource based on the first priority, the second priority, and the determination that the trigger condition is satisfied.

In an additional aspect of the disclosure, a UE includes one or more processors and one or more memories coupled to the one or more processors. The one or more processors are configured to measure a reference signal transmitted by a network node, wherein the network node is a candidate serving cell, determine that a trigger condition for transmission of a first report is satisfied based on the measurement of the reference signal, determine that a first resource for transmission of the first report overlaps with a second resource for transmission of a second report, determine a first priority of the first report and a second priority of the second report, and transmit the first report on the first resource based on the first priority, the second priority, and the determination that the trigger condition is satisfied.

In an additional aspect of the disclosure, a UE includes means for measuring a reference signal transmitted by a network node, wherein the network node is a candidate serving cell, means for determining that a trigger condition for transmission of a first report is satisfied based on the measurement of the reference signal, means for determining that a first resource for transmission of the first report overlaps with a second resource for transmission of a second report, means for determining a first priority of the first report and a second priority of the second report, and means for transmitting the first report on the first resource based on the first priority, the second priority, and the determination that the trigger condition is satisfied.

In an additional aspect of the disclosure, a non-transitory computer-readable medium stores instructions that, when executed by a processor, cause the processor to perform operations. The operations include measuring a reference signal transmitted by a network node, wherein the network node is a candidate serving cell, determining that a trigger condition for transmission of a first report is satisfied based on the measurement of the reference signal, determining that a first resource for transmission of the first report overlaps with a second resource for transmission of a second report, determining a first priority of the first report and a second priority of the second report, and transmitting the first report on the first resource based on the first priority, the second priority, and the determination that the trigger condition is satisfied.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram of an example UE and a plurality of base stations according to one or more aspects.

FIG. 4 is a block diagram illustrating an example wireless communication system that supports prioritization of event triggered mobility reports according to one or more aspects.

FIG. 5 is a block diagram of a change in reference signal measurements for a plurality of candidate serving cells over time according to one or more aspects.

FIG. 6 is a flow diagram illustrating an example process that supports prioritization of event triggered mobility reports according to one or more aspects.

FIG. 7 is a flow diagram illustrating an example process that supports prioritization of event triggered mobility reports according to one or more aspects.

FIG. 8 is a flow diagram illustrating an example process that supports prioritization of event triggered mobility reports according to one or more aspects.

FIG. 9 is a flow diagram illustrating an example process that supports prioritization of event triggered mobility reports according to one or more aspects.

FIG. 10 is a block diagram of an example base station that supports prioritization of event triggered mobility reports according to one or more aspects.

FIG. 11 is a block diagram of an example UE that supports prioritization of event triggered mobility reports according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), 6G networks, as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

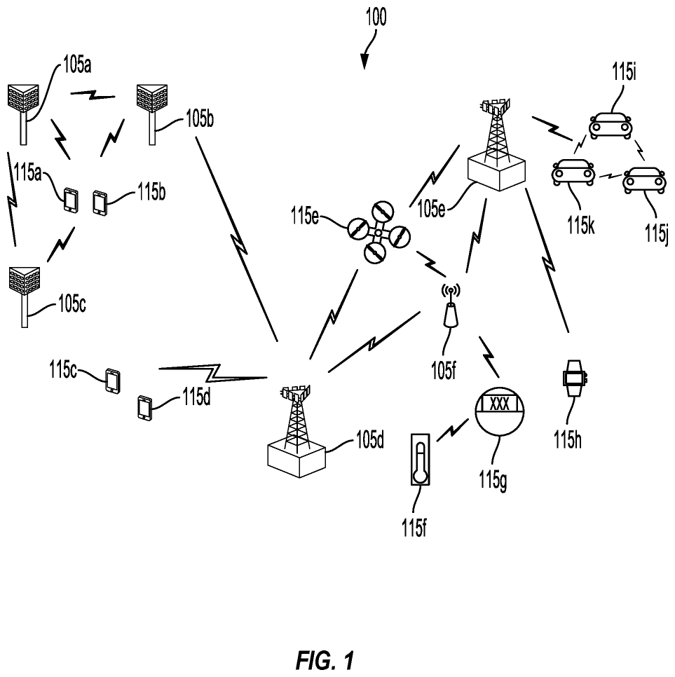

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

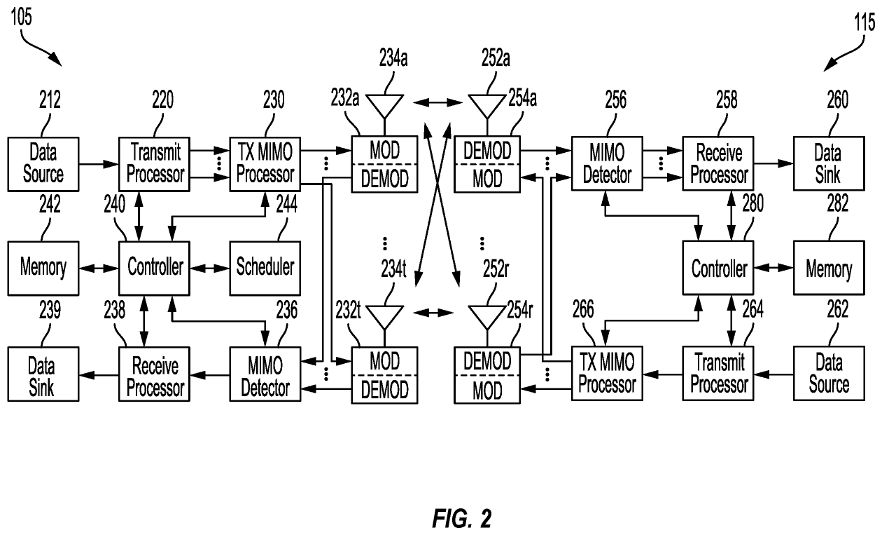

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

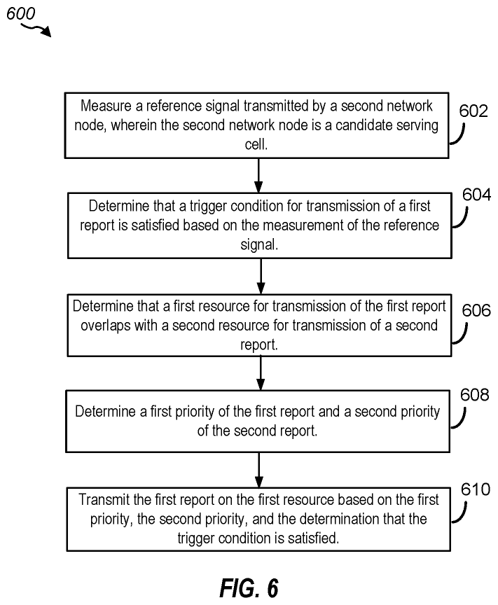

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 6-9, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The present disclosure provides systems, apparatus, methods, and computer-readable media that support prioritization of event triggered mobility reports, such as when two or more reports are scheduled to be transmitted using a same resource. For example, a UE may measure a reference signal transmitted by a network node, such as a base station, that is a candidate serving cell. Based on the measured reference signal, the UE may determine that a trigger condition for transmission of a first report is satisfied. For example, the UE may determine that a signal quality from the network node is superior to a signal quality from a current serving cell. The transmission of the first report, however, may be configured to be performed on a same resource, such as a same time and/or frequency resource, as transmission of another, second, report. The UE may determine priorities of the first and second reports, such as based on report types of the first and second reports and other characteristics of the first and second reports. The UE may then transmit the first report using the resource based on the determination that the trigger condition is satisfied and the priorities of the first and second reports. Thus, conflicts between reports configured for transmission using a same resource may be resolved.

Particular implementations of the subject matter described in this disclosure may be implemented to realize one or more of the following potential advantages or benefits. In some aspects, the present disclosure provides techniques for prioritization of event triggered mobility reports. Such prioritization may allow for resolution of conflicts when reports are configured to be transmitted using a same resource. For example, transmission of reports based on priority of such reports may allow for higher priority information to be provided to a base station before lower priority information, enhancing network efficiency. As one example, such prioritization may enhance flexibility in timing of transmission of mobility reports, allowing for a UE to be transferred more quickly as network conditions change. Such transfer may enhance a signal strength for a UE as well as reduce power consumption by the UE.

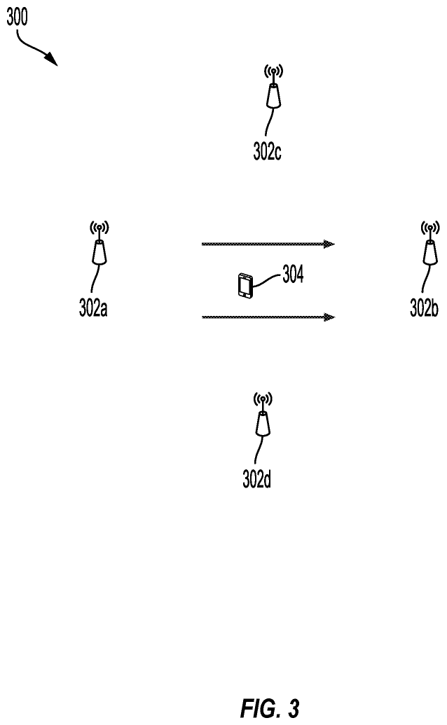

An example network 300 is shown in FIG. 3. A first UE 304, may be served by a first serving cell 302A. Candidate serving cells 302b-d may transmit reference signals for measurement by the UE 304 to facilitate layer 1/layer 2 triggered mobility (LTM) allowing the UE to transition from being served by the current serving cell 302a to one of the candidate serving cells 302b-d. For example, L1/L2 signaling for switching between serving cells may facilitate mobility in lower layers, introducing less latency than L3 mobility signaling.

The UE 304 may measure one or more layer 1 (L1) transmissions, such as reference signals, sent by the candidate serving cells 302b-d. For example, the UE 304 may measure a reference signal received power (RSRP) for each of multiple reference signals transmitted by the candidate serving cells 302b-d. Based on the measured reference signals, the UE 304 may determine that a trigger condition for LTM is met. For example, the UE 304 may determine that candidate serving cell 302b has a superior signal quality to current serving cell 302a. The UE 304 may use L1/L2 signaling to transmit a report including measurements of the reference signal from the candidate serving cell 302b, and, in some embodiments, measurements of other reference signals from other candidate serving cells 302c-d, to the serving cell 302a. The report may be transmitted using resources shared with other reports and transmissions between the UE 304 and the serving cell 302a. If the report is to be transmitted using a same resource as another report or other transmission, the UE may compare priorities of the reports to determine if and when to transmit each report. The old serving cell 302a may then handover the UE 304 to the new serving cell 302b.

As one particular example, candidate cells 302b-d may be candidate primary cells (PCells). In some embodiments, separate signaling may be used for transition of serving PCells and secondary cells (SCells). For example, SCell selection may be based on legacy signaling or L1/L2 signaling, such as downlink control information (DCI) or media access control control element (MAC-CE) signaling. In some embodiments, for example, the UE 304 may determine, based on reference signals transmitted by candidate PCells 302b-d that the UE 304 should transition from being served by the serving cell 302a to being served by the candidate serving cell 302b. Thus, a single PCell 302b without carrier aggregation or dual connectivity may be selected to serve the UE 304 as a new serving cell, and the UE 304 may transition from being served by the serving cell 302a to being served by the new serving cell 302b using L1/L2 signaling.

As another example, the UE 304 may be served by serving PCell 302a, while candidate cells 302b-d may be configured as SCells. In such a scenario, the UE 304 may receive reference signals from SCells 302b-d. Based on measurements of such reference signals, the old serving PCell 302a may be configured as an SCell, while a selected SCell 302b may be configured as the new serving PCell.

As another example, in a carrier aggregation scenario, cell 302a may represent a serving carrier group, while cells 302b-d may represent candidate carrier groups. Based on measurements of reference signals from candidate carrier groups 302b-d, the UE 304 may transition from being served by an old carrier group 302a to a new carrier group 302b. In such embodiments, SpCells and SCells may be switched together when moving between different carrier groups.

Reporting of measurements of reference signals from candidate serving cells 302b-d may be performed using L1/L2 signaling, and may coexist with other periodic, semi-periodic, and aperiodic reporting. In some embodiments, the UE 304 may use the same resources allocated for transmission of other periodic, semi-periodic, and aperiodic reports to transmit LTM reports triggered by measurements of reference signals from candidate serving cells 302b-d to serving cell 302a. Prioritization of such coexisting reporting may allow for enhanced efficiency in supporting LTM and resolution of conflicts when the same resources are used for both LTM signaling and transmission of other reports.

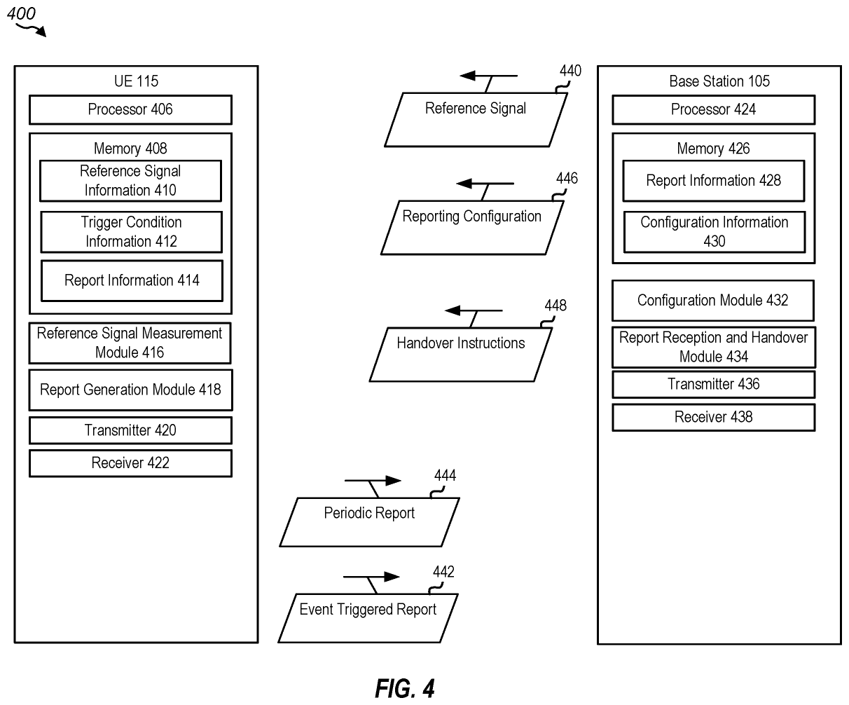

FIG. 4 is a block diagram of an example wireless communications system 400 that supports prioritization of event triggered mobility reports according to one or more aspects. In some examples, wireless communications system 400 may implement aspects of wireless network 100. Wireless communications system 400 includes UE 115 and base station 105. Although one UE 115 and one base station 105 are illustrated, in some other implementations, wireless communications system 400 may generally include multiple UEs 115, and may include more than one base station 105. UE 115 and base station 105 may be examples of network nodes.

UE 115 may include a variety of components (such as structural, hardware components) used for carrying out one or more functions described herein. For example, these components may include one or more processors 406 (hereinafter referred to collectively as “processor 406”), one or more memory devices 408 (hereinafter referred to collectively as “memory 408”), one or more transmitters 420 (hereinafter referred to collectively as “transmitter 420”), and one or more receivers 422 (hereinafter referred to collectively as “receiver 422”). Processor 406 may be configured to execute instructions stored in memory 408 to perform the operations described herein. In some implementations, processor 406 includes or corresponds to one or more of receive processor 258, transmit processor 264, and controller 280, and memory 408 includes or corresponds to memory 282.

Memory 408 includes or is configured to store reference signal information 410, trigger condition information 412, and report information 414. Reference signal information 410 may include information indicating one or more resources on which reference signals will be transmitted, information indicating one or more measurements to be performed on one or more reference signals, information indicating one or more measurements performed on the one or more reference signals, such as values of one or more measurements, one or more cell identifiers (IDs) associated with the one or more reference signals, one or more reference signal IDs, one or more sounding reference signal (SRS) port numbers for beams of one or more reference signals, and other reference signal information. Trigger condition information 410 may include one or more trigger conditions for transmission of one or more reports, such as LTM reports, based on one or more measurements of one or more reference signals. Report information 414 may include information indicating one or more items included in a report, such as a cell ID, a reference signal ID, measured RSRP values, other measured parameters, one or more priority values of one or more reports and/or sections of one or more reports, one or more indicators of whether a report was sent as a result of a comparison of a priority of the report with one or more other reports, one or more sections of a report, and other information. Report information 414 may include one or more channel state information (CSI) reports generated based on one or more measurements of one or more reference signals from one or more candidate serving cells. Report information 414 may also include information for other uplink control information (UCI), such as ACK/NACK information, status request information, and other information.

Transmitter 420 is configured to transmit reference signals, control information and data to one or more other devices, and receiver 422 is configured to receive references signals, synchronization signals, control information and data from one or more other devices. For example, transmitter 420 may transmit signaling, control information and data to, and receiver 422 may receive signaling, control information and data from, base station 105. In some implementations, transmitter 420 and receiver 422 may be integrated in one or more transceivers. Additionally or alternatively, transmitter 420 or receiver 422 may include or correspond to one or more components of UE 115 described with reference to FIG. 2.

UE 115 may include a reference signal measurement module 416 for measuring one or more reference signals transmitted by one or more candidate serving cells. For example, reference signal measurement module 416 may cause the UE 115 to measure an RSRP of one or more reference signals transmitted by one or more base stations other than serving base station 105. UE 115 may further include a report generation module 418. When one or more measured reference signals meet a trigger condition, such as a trigger condition of trigger condition information 412, report generation module 418 may cause the UE 115 to generate a report, such as a CSI report, and may cause the UE 115 to transmit the report to the base station 105. If the report is to be transmitted on a same resource as other UCI, such as another CSI report, the report generation module 418 may compare a priority of the report with one or more priorities of other reports to be transmitted using the same resources. A report may be determined for transmission on a same resource as other UCI when the report is determined for transmission using a same set of time and frequency resources. The report generation module 418 may cause the UE 115 to transmit the report based on the comparison of the priority of the report with priorities of other reports.

Base station 105 may include a variety of components (such as structural, hardware components) used for carrying out one or more functions described herein. For example, these components may include one or more processors 424 (hereinafter referred to collectively as “processor 424”), one or more memory devices 426 (hereinafter referred to collectively as “memory 426”), one or more transmitters 436 (hereinafter referred to collectively as “transmitter 436”), and one or more receivers 438 (hereinafter referred to collectively as “receiver 438”). Processor 424 may be configured to execute instructions stored in memory 426 to perform the operations described herein. In some implementations, processor 424 includes or corresponds to one or more of receive processor 238, transmit processor 220, and controller 240, and memory 426 includes or corresponds to memory 242.

Memory 426 includes or is configured to store report information 428 and configuration information 430. Report information 428 may, for example, include report information 414 received from UE 115 and other report information. Configuration information 430 may include configuration information for configuring UE 115 to measure one or more reference signals transmitted by one or more candidate serving base stations other than base station 105, information regarding one or more trigger conditions for triggering handover of the UE 115 from the base station 105 to a different candidate serving base station, and other configuration information.

Transmitter 436 is configured to transmit reference signals, synchronization signals, control information and data to one or more other devices, and receiver 438 is configured to receive reference signals, control information and data from one or more other devices. For example, transmitter 436 may transmit signaling, control information and data to, and receiver 438 may receive signaling, control information and data from, UE 115. In some implementations, transmitter 436 and receiver 438 may be integrated in one or more transceivers. Additionally or alternatively, transmitter 436 or receiver 438 may include or correspond to one or more components of base station 105 described with reference to FIG. 2.

Base station 105 may further include a configuration module 432 for configuring the UE 115 for LTM. For example, the configuration module 432 may cause the base station 105 to transmit configuration information 430 to the UE 115 to configure the UE 115 for LTM. Base station 105 may also include a report reception and handover module 434. The report reception and handover module 434 may cause the base station 105 to receive one or more reports, such as one or more L1/L2 reports, from the UE 115 for triggering a handover of the UE 115 from the base station 105 to a different candidate serving base station. The report reception and handover module 434 may, upon reception of a report from the UE 115, initiate handover of the UE 115 to a new serving base station.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP.

During operation of wireless communications system 400, the base station 105 may transmit a reference signal 440. In some embodiments, the base station 105 may be a serving base station, and the reference signal 440 may be transmitted by one or more candidate serving base stations, different from the base station 105. For example, each of multiple candidate serving base stations may transmit reference signals 440. In some embodiments, the base station 105 may be a PCell, and one or more reference signals 440 may be transmitted by one or more SCells and received by the UE 115. The reference signal 440 may, for example, be an L1/L2 reference signal. The UE 115 may receive the reference signal 440 and may perform one or more measurements on the reference signal 440. For example, the UE 115 may measure an RSRP of the reference signal 440. For example, the UE 115 may receive reference signals 440 from one or more candidate serving cells other than the base station 105, which may be a current serving cell.

The report generation module 418 of the UE 115 may determine, based on the measurements of the one or more reference signals 440 that a trigger condition is satisfied for handover of the UE 115 from the base station 105 to a different base station and may generate a report 442 for L1/L2 transmission to the base station 105. In some embodiments, the report generation module 418 may transmit an event triggered report 442 based on a priority of the event triggered report 442 and one or more other reports or other UCI configured to be transmitted on a same resource. For example, the UE 115 may compare a priority of the event triggered report 442 with a priority of another report configured to be transmitted on the same resource, such as a periodic report 444, may determine that a priority of the event triggered report 442 is higher than a priority of the other report, such as the periodic report 444, and may transmit the event triggered report 442 based on the determination that the priority of the event triggered report 442 is higher than the priority of the other report, such as the periodic report 444. In some embodiments, transmission of the periodic report 444 may be delayed based on the comparison of the priorities, and the event triggered report 442 may include an indicator, such as an indication in a reserved bit field or an indication in a demodulation reference signal (DMRS) scrambling used for the event triggered report 442 that the event triggered report 442 is transmitted based on a comparison of a priority of the event triggered report 442 with a priority of one or more other reports. Such an indication may inform the base station 105 that the event triggered report 442 was transmitted in place of a periodic report 444 that was configured to be transmitted on the resource.

The base station 105 may receive the event triggered report 442, and the report reception and handover module 434 may cause the base station 105 to transmit handover instructions 448 to the UE 115 and to a selected candidate serving cell. In some embodiments, the base station 105 may transmit a reporting configuration 446 to the UE 115. The reporting configuration 446 may, for example, include information regarding one or more trigger conditions for LTM, an indication of one or more resources to monitor for one or more reference signals from one or more candidate base stations, and an indication of one or more resources on which the UE 115 should transmit the event triggered report 442. Thus, a UE 115 may transmit an event triggered report 442 using L1/L2 resources based on a priority of the event triggered report and one or more priorities of other UCI to be transmitted using the same resources.

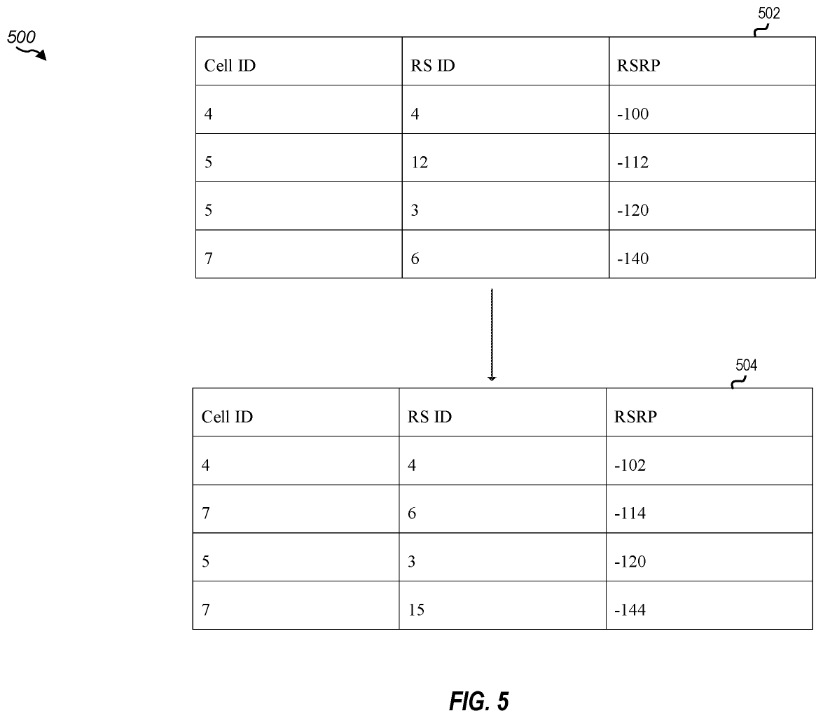

A variety of different trigger conditions may be used trigger transmission of a report, such as a CSI report for LTM. A UE may measure reference signals for a plurality of beams from a plurality of candidate serving cells, and reports may be transmitted based on the outcome of such measurements. As one example, for a first trigger condition, if a strength of a best beam among all measured beams, or a subset of beams indicated by the serving cell, such as an RSRP of a best beam, is greater or smaller than a threshold value or a strength of a best beam of a serving cell, with the addition of an offset in some embodiments, a trigger condition for transmission of a report may be satisfied. As another example, a second trigger condition for transmission of a report may require satisfaction of the first trigger condition and a change in an ID of a best beam of the candidate serving cell following a prior measurement. As another example, a third trigger condition for transmission of a report may require a change in an order of candidate cell ID associated with good beams. For example, a good beam may be defined as a beam within a top number of beams having a measured RSRP above a threshold value. An example diagram 500 showing a change in an order of candidate cell IDs associated with good beams is shown in FIG. 5. At a first time, a first order 502 of beams associated with reference signal IDs and cell IDs may be determined by measuring one or more reference signals transmitted by one or more cells. At a second time, a second order 504 of beams may be different from the first order 502 of beams. For example, at the first time a first beam having a cell ID of 5 and a RS ID of 3 may have a higher RSRP than a second beam having a cell ID of 7 and an RS ID of 6. At the second time, the first beam may have a lower RSRP than the second beam. Based on the change in order of the beams, transmission of a report may be triggered. Likewise, if a new beam joins the list of best beams and an old beam leaves the list of best beams, such as resulting from deteriorating or improving signal quality, the order of beams may change and transmission of a report may be triggered. Thus, reporting, such as CSI reporting, may be triggered by satisfaction of one or more trigger conditions.

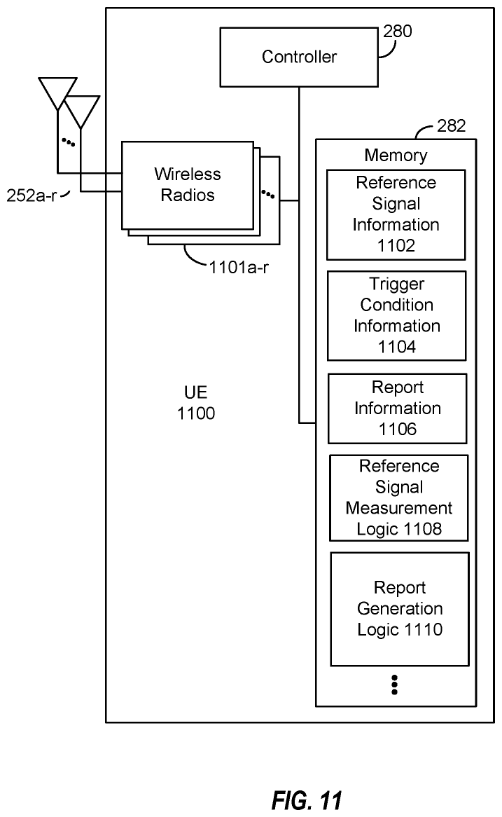

FIG. 6 is a flow diagram illustrating an example process 600 that supports prioritization of event triggered mobility reports according to one or more aspects. Operations of process 600 may be performed by a UE, such as UE 115 described above with reference to FIG. 1, 2 or 4, or a UE described with reference to FIG. 11. For example, example operations (also referred to as “blocks”) of process 600 may enable UE 115 to support prioritization of event triggered mobility reports.

In block 602, a UE may measure a reference signal transmitted by a network node. The network node may, for example, be a candidate serving cell, such as a base station. The reference signal may, for example, be an L1 reference signal, and the UE may measure an L1 metric of the first reference signal, such as an RSRP of one or more beams of the first reference signal. In some embodiments, the UE may determine to measure one or more reference signals from one or more candidate serving cells based on a configuration received from a base station, such as a configuration identifying one or more cell IDs, such as physical cell IDs, and reference signal IDs associated with one or more reference signals for measurement by the UE. In some embodiments, the UE may identify a physical cell ID and/or reference signal ID of the reference signal based on physical cell ID and reference signal ID detection.

In block 604, the UE may determine that a trigger condition for transmission of a first report is satisfied based on the measurement of the reference signal. For example, the UE may compare one or more measurements of the first reference signal with one or more threshold parameters associated with a trigger condition to determine if the trigger condition is met. As another example, the UE may compare the measurement of the reference signal with one or more measurements of one or more other reference signals from other candidate serving cells. A first example trigger condition may include a measured parameter of a best beam among all or a subset of beams measured for one or more candidate serving cells being greater or smaller than a threshold value or a measured parameter of the serving cell summed with an offset value. A second example trigger condition may include a change in an ID of a best beam determined based on one or more measurements of one or more reference signals following a prior beam measurement. A third example trigger condition may include a change in an order of measured parameters of candidate serving cell IDs associated with good beams, as discussed herein. For example, the third example trigger condition may include a change in an order of a top number of beams organized based on measured RSRP values. In some embodiments, trigger conditions may include a combination of two or more of the aforementioned example trigger conditions and/or other trigger conditions. Trigger conditions may, in some embodiments, mirror those used for layer 3 (L3) mobility trigger conditions. L1 metrics, such as RSRP of transmitted reference signals, may require fewer resources for computation than L3 metrics and may better capture short term channel changes on a single beam. In some embodiments, a filtered L1 metric may be different from a cell level metric defined for legacy L3 events, such as including filtering only in the time domain. Filtering of L1 metrics may be predefined in a memory of the UE or indicated to the UE by a network node.

In block 606, the UE may determine that a first resource for transmission of a first report overlaps with a second resource for transmission of a second report. For example, a same time and/or frequency resource or set of resources may be used for L1/L2 mobility report transmissions and other report transmissions. The triggered first report may, for example, include UCI, such as a CSI report, transmitted on one or more physical uplink control channel (PUCCH) or physical uplink shared channel (PUSCH) resources. Thus, the triggered first report, such as a CSI report, may be sent on a preconfigured PUSCH or PUCCH resource, and a base station may perform blind decoding to detect whether a report is triggered. As one particular example, resources for a triggered CSI report may overlap with resources for other UCI types. In such instances, a multiplexing rule may be applied, where ACK/NACK UCI is given priority over status report UCI and status report UCI is given priority over CSI reports. When a report, such as a CSI report, overlaps with another report, such as another CSI report, priorities of the reports may be considered in determining transmission of the reports. As one example, the first report may overlap with a periodic, semi-periodic, or aperiodic second report. A first report may overlap with another report when time and/or frequency resources allocated for transmission of the first report overlap with time and/or frequency resources allocated for transmission of the other report.

In block 608, a first priority of the first report and a second priority of the second report may be determined. For example, determination of the first priority may include calculating a first priority metric for the first report based on a first report type of the first report. The first priority metric may be calculated based on the first report being an event triggered report, triggered by satisfaction of a trigger condition. Determination of the second priority may include calculating a second priority metric for the second report based on a second report type of the second report. The second priority metric may be calculated based on the second report being a periodic, semi-periodic, or aperiodic report. Thus, report types used in calculation of a priority metric may include an event triggered report type, a periodic report type, a semi-periodic report type, and an aperiodic report type. As one particular example, a priority metric for each report may be determined in accordance with the following equation: Pri_{iCSI}(y,k,c,s)=2·N_{cells} M_{S} y+N_{cells} M_{S} k+Mₛ c+s. N_{cells} may represent a candidate number of serving cells, Mₛ may represent a maximum number of reports configured for transmission, y may represent a type of report, c may represent a serving cell ID, k may represent whether an L1 RSRP/signal to interference and noise ratio (SINR) is sent, and s may represent a report configuration ID. For example, y may be set to a value of 0 when a report is aperiodic, 1 when a report is an event triggered report of a first type, 2 when a report is an event triggered report of a second type, 3 when a report is semi-periodic PUSCH report, 4 when a report is a semi-periodic PUCCH report, and 5 when a report is periodic. Thus, a priority metric value may depend on a type of the report for which the priority metric is being calculated. Different types of event triggered reports may, for example, be associated with different trigger conditions as discussed herein. The k variable may be set to 0 if an L1 RSRP/SINR is sent and 1 if no L1 RSRP/SINR is sent. Reports with lower priority metrics may be given priority for transmission over reports with higher priority metrics. Thus, if all other variables are equal, an aperiodic report may have a higher priority than an event triggered report, and an event triggered report may have a higher priority than a semi-periodic or periodic report.

In block 610, the UE may transmit the first report on the first resource based on the first priority, the second priority, and the determination that the trigger condition is satisfied. The first report may, for example, be transmitted to a second network node, such as a base station configured as a current serving cell. For example, satisfaction of the trigger condition may trigger transmission of the report by the UE, and the UE may determine a time for transmission of the first report based on a comparison of a priority of the first report and the second report. For example, if the first report has a higher priority than the second report, the first report may be transmitted before the second report, and the transmission of the second report may be delayed. Thus, a UE may compare priorities of LTM reports configured to be transmitted using a same resource and may prioritize transmission of the reports based on the comparison of priorities.

The first report transmitted in block 610 may include one or more cell IDs, such as physical cell IDs (PCIs) and one or more reference signal IDs, such as one or more beam IDs or one or more transmission configuration indicator (TCI) IDs, associated with one or more measurements, such as one or more RSRP measurements, included in the report. In some embodiments, the first report may include a group based beam report of beam pairs that the UE is configured to receive and transmit at the same time, such as for simultaneous DL/UL transmission and reception for a candidate cell. In some embodiments, the first report may include one or more SRS port numbers for each reported beam of the report associated with one or more reference signal IDs. In some embodiments, the first report may include an indication that prioritization of the first report was performed to inform the base station that the first report is an event triggered report. For example, if a periodic or semi-periodic report was scheduled to be transmitted on the resource and the first report was transmitted instead based on a comparison of priorities of the first report and the periodic or semi-periodic report, the base station may be expecting the periodic or semi-periodic report rather than the first report. In some embodiments the first report and a periodic or semi-periodic report may have a same payload and format but may include different measurements of different cells. As a result blind decoding by the base station may not always allow the base station to determine the type of report that is received. Thus, when the first report is transmitted, for example on a PUCCH, based on a comparison of priority values, an indication that the report is a triggered report may be included in the report. Such an indication may, for example, include a bit or a bit field indicating that the report was transmitted as a result of a comparison of priority values. As another example, such an indication may include use of a particular scrambling sequence for a DMRS of the report.

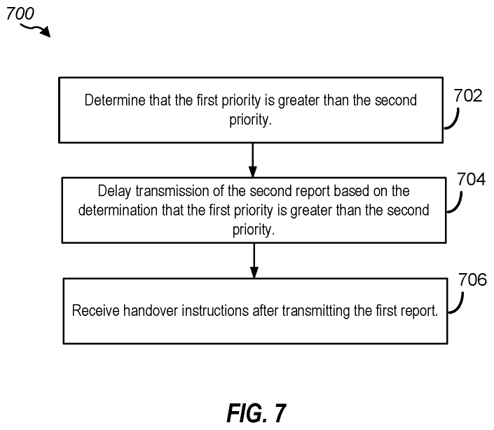

As one particular example, if the first report has a higher priority than the second report, as described with respect to FIG. 6, the UE may transmit the first report before transmitting the second report. FIG. 7 is a flow diagram illustrating an example process 700 that supports prioritization of event triggered mobility reports according to one or more aspects. Operations of process 700 may be performed by a UE, such as UE 115 described above with reference to FIG. 1, 2 or 4, or a UE described with reference to FIG. 11. For example, example operations (also referred to as “blocks”) of process 700 may enable UE 115 to support prioritization of event triggered mobility reports.

In block 702, the UE may determine that the first priority is greater than the second priority. Such a determination may, for example, be made based on a comparison of the priority values determined at block 608 of FIG. 6.

In block 704, the UE may delay transmission of the second report based on the determination that the first priority is greater than the second priority. For example, the UE may transmit the first report using the first resource, as described with respect to block 610 of FIG. 6 and may delay transmission of the second report, scheduled to be transmitted using the first resource, to a later time.

In block 706, the UE may receive handover instructions after transmitting the first report. For example, when a second network node, such as a base station configured as a current serving cell different from the first network node, receives the first report, the second network node may determine that the UE should be transferred to a new serving base station, such as a serving base station indicated by the first report. The base station may initiate a handover procedure, and the UE may receive handover instructions from the base station as part of the handover procedure.

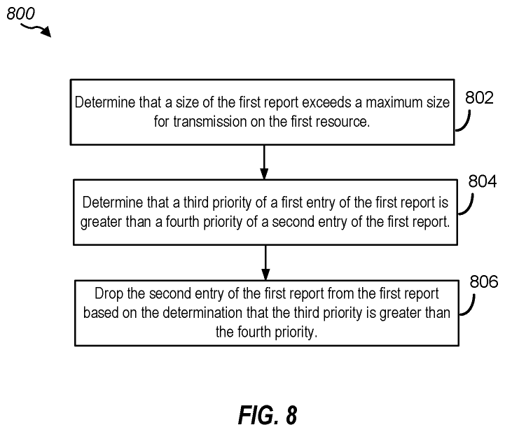

In some embodiments, a size of the first report described with respect to FIGS. 6 and 7 may exceed a maximum size requirement for transmission on the first resource. Thus, the UE may prioritize particular entries of a report and may drop one or more entries of the report to allow the report to remain within the maximum size requirements of the first resource. FIG. 8 is a flow diagram illustrating an example process 800 that supports prioritization of event triggered mobility reports according to one or more aspects. Operations of process 800 may be performed by a UE, such as UE 115 described above with reference to FIG. 1, 2 or 4, or a UE described with reference to FIG. 11. For example, example operations (also referred to as “blocks”) of process 800 may enable UE 115 to support prioritization of event triggered mobility reports.

In block 802, the UE may determine that a size of the first report exceeds a maximum size for transmission on the first resource. For example, the size of the first report described with respect to FIGS. 6 and 7 may exceed a maximum size for transmission on the first resource.

In block 804, the UE may determine that a third priority of a first entry of the first report is greater than a fourth priority of a second entry of the first report. For example, entries of the first report, such as an L1 candidate cell CSI report, may be assigned priorities, and the UE may determine entries with higher priorities to be included in the report. An L1 candidate cell CSI report may be an example of an LTM report. As one particular example, entries of an L1 candidate cell CSI report may be prioritized based on values of the reported metrics of the report, such as measured RSRP values, and/or cell IDs associated with the entries of the report. In some embodiments a base station may indicate to the UE which entries of a report should be prioritized in advance. As another example, report entries associated with different beams of a same cell may be prioritized based on RSRP values associated with the beams.

In block 806, the UE may drop the second entry of the first report from the first report based on the determination that the third priority is greater than the fourth priority. For example, the UE may drop entries from the first report in order of ascending priority until a size of the first report falls within a maximum size requirement for transmission on the first resource. Thus based on a payload of the resource that the report is to be transmitted on, such as a payload of a PUCCH, lower priority entries may be dropped from transmission of the report.

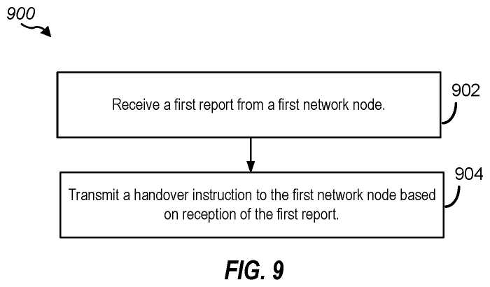

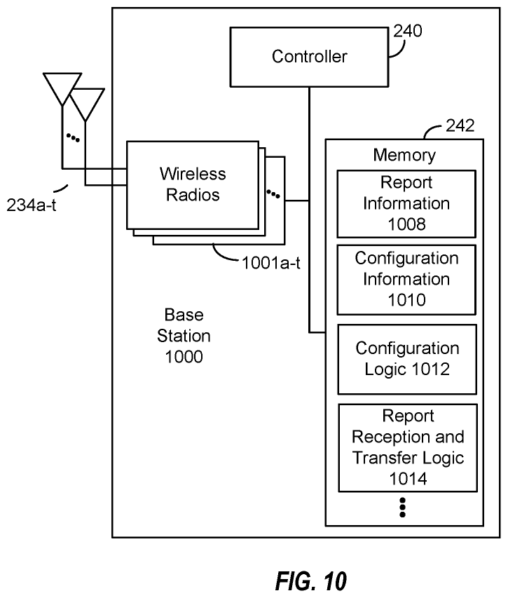

FIG. 9 is a flow diagram illustrating an example process 900 that supports prioritization of event triggered mobility reports according to one or more aspects. Operations of process 900 may be performed by a base station, such as base station 105 described above with reference to FIG. 1, 2, or 4 or a base station as described above with reference to FIG. 10. For example, example operations of process 900 may enable base station 105 to support prioritization of event triggered mobility reports.

In block 902, a second network node, such as a base station configured as a current serving cell different from a candidate serving cell, may receive a first report from a UE. The first report may, for example, be a report transmitted as described with respect to block 610 of FIG. 6. In some embodiments, the base station may determine that the report is an event triggered report transmitted based on a comparison of a priority value of the report with a priority value of another report, such as a periodic report, based on an indicator included in the report. Thus, the base station may determine that the report is not a periodic report that was scheduled to be transmitted using a resource on which the report was transmitted.

In block 904, the second network node may transmit a handover instruction to the UE based on reception of the first report. For example, the second network node may initiate a handover procedure based on the received first report for the first network node described with respect to block 602 of FIG. 6 to serve as a new serving cell for the UE.

FIG. 10 is a block diagram of an example base station 1000 that supports prioritization of event triggered mobility reports according to one or more aspects. Base station 1000 may be configured to perform operations, including the blocks of process 900 described with reference to FIG. 9. In some implementations, base station 900 includes the structure, hardware, and components shown and described with reference to base station 105 of FIGS. 1, 2, and 4. For example, base station 1000 may include controller 240, which operates to execute logic or computer instructions stored in memory 242, as well as controlling the components of base station 1000 that provide the features and functionality of base station 1000. Base station 1000, under control of controller 240, transmits and receives signals via wireless radios 1001a-t and antennas 234a-t. Wireless radios 1001a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include report information 1008, configuration information 1010, configuration logic 1012, and report reception and transfer logic 1014. Report information 1008 may include information as described with respect to report information 428 of FIG. 4 and other information. Configuration information 1010 may include information as described with respect to configuration information 430 of FIG. 4 and other information. Configuration logic 1012 may be configured to generate and transmit configuration instructions to UE 1100, such as instructions for configuring the UE 1100 for measuring reference signals from candidate serving cells, detecting when such measurements meet one or more trigger conditions for transmission of a report, determining and comparing priorities of reports configured to be transmitted on a same resource or set of resources, and transmitting such reports. Report reception and transfer logic 1014 may be configured to receive such reports from UEs, such as UE 1100, and initiate handover procedures based on such reports. Base station 1000 may receive signals from or transmit signals to one or more UEs, such as UE 115 of FIGS. 1, 2, and 4 or UE 1100 of FIG. 11.

FIG. 11 is a block diagram of an example UE 1100 that supports prioritization of event triggered mobility reports to one or more aspects. UE 1100 may be configured to perform operations, including the blocks of a process described with reference to FIGS. 6-8. In some implementations, UE 1100 includes the structure, hardware, and components shown and described with reference to UE 115 of FIGS. 1, 2, and 4. For example, UE 1100 includes controller 280, which operates to execute logic or computer instructions stored in memory 282, as well as controlling the components of UE 1100 that provide the features and functionality of UE 1100. UE 1100, under control of controller 280, transmits and receives signals via wireless radios 1101a-r and antennas 252a-r. Wireless radios 1101a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include reference signal information 1102, trigger condition information 1104, report information 1106, reference signal measurement logic 1108, and report generation logic 1110. Reference signal information may include information as described with respect to reference signal information 410 of FIG. 4 and other information. Trigger condition information 1104 may include information as described with respect to trigger condition information 412 of FIG. 4 and other information. Report information 1106 may include information as described with respect to report information 414 of FIG. 4 and other information. Reference signal measurement logic 1108 may be configured to perform one or more measurements on one or more reference signals received from one or more candidate serving cells as described herein. Report generation logic 1110 may be configured to determine whether one or more trigger conditions are satisfied based on reference signal information 1102, generate one or more reports, compare one or more priorities of one or more reports configured for transmission using a same resource, transmit reports, delay transmission of reports, and drop sections of reports as described herein. UE 1100 may receive signals from or transmit signals to one or more network entities, such as base station 105 of FIGS. 1, 2, and 4 or a base station as illustrated in FIG. 10.

It is noted that one or more blocks (or operations) described with reference to FIGS. 6-9 may be combined with one or more blocks (or operations) described with reference to another of the figures. For example, one or more blocks (or operations) of FIG. 6 may be combined with one or more blocks (or operations) of FIG. 7. As another example, one or more blocks associated with FIG. 7 may be combined with one or more blocks associated with FIG. 8. As another example, one or more blocks associated with FIGS. 6-9 may be combined with one or more blocks (or operations) associated with FIGS. 1, 2, and 4. Additionally, or alternatively, one or more operations described above with reference to FIGS. 1, 2, and 4 may be combined with one or more operations described with reference to FIG. 10 or 11.

In one or more aspects, techniques for supporting prioritization of event triggered reports may include additional aspects, such as any single aspect or any combination of aspects described below or in connection with one or more other processes or devices described elsewhere herein. In a first aspect, supporting prioritization of event triggered reports may include an apparatus, such as a UE configured to measure a reference signal transmitted by a network node, wherein the network node is a candidate serving cell, determine that a trigger condition for transmission of a first report is satisfied based on the measurement of the reference signal, determine that a first resource for transmission of the first report overlaps with a second resource for transmission of a second report, determine a first priority of the first report and a second priority of the second report, and transmit the first report on the first resource based on the first priority, the second priority, and the determination that the trigger condition is satisfied. Additionally, the apparatus may perform or operate according to one or more aspects as described below. In some implementations, the apparatus may be a UE and may include a wireless device. In some implementations, the apparatus may include one or more processors, and one or more memories coupled to the one or more processors. The one or more processors may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, to determine the first priority of the first report and the second priority of the second report the apparatus may be further configured to calculate a first priority metric for the first report based on a first report type of the first report and calculate a second priority metric for the second report based on a second report type of the second report.

In a third aspect, in combination with one or more of the first aspect or the second aspect, the first report type comprises at least one of an event triggered report type, a periodic report type, a semi-periodic report type, or an aperiodic report type, and the second report type comprises at least one of an event triggered report type, a periodic report type, a semi-periodic report type, or an aperiodic report type.

In a fourth aspect, in combination with one or more of the first aspect through the third aspect, the first report comprises a first channel state information (CSI) report, and the second report comprises a second CSI report.

In a fifth aspect, in combination with one or more of the first aspect through the fourth aspect, the apparatus is further configured to determine that the first priority is greater than the second priority and delay transmission of the second report based on the determination that the first priority is greater than the second priority.

In a sixth aspect, in combination with one or more of the first aspect through the fifth aspect, the first report comprises an indication that transmission of the first report was triggered by satisfaction of the trigger condition.

In a seventh aspect, in combination with one or more of the first aspect through the sixth aspect, the indication comprises at least one of a bit field of the first report or a scrambling sequence of a demodulation reference signal (DMRS) of the first report.

In an eighth aspect, in combination with one or more of the first aspect through the seventh aspect, the apparatus is further configured to determine that a size of the first report exceeds a maximum size for transmission on the first resource, determine that a third priority of a first entry of the first report is greater than a fourth priority of a second entry of the first report, drop the second entry of the first report from the first report before transmitting the first report on the first resource based on the determination that the third priority of the first entry is greater than the fourth priority of the second entry.

In a ninth aspect, in combination with one or more of the first aspect through the eighth aspect, the first report comprises at least one of a cell identifier (ID) of the candidate serving cell, a reference signal ID of the measured reference signal, a measured metric of the measured reference signal, an indication of one or more beam pairs that the UE is configured to transmit and receive simultaneously, or a sounding reference signal (SRS) port number associated with the reference signal ID of the measured reference signal.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1, 2, 4 and 11-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A user equipment (UE), comprising:
one or more memories; and
one or more processors coupled to the one or more memories, wherein the one or more processors are configured to:
measure a reference signal transmitted by a network node, wherein the network node is a candidate serving cell;
determine that a trigger condition for transmission of a first report is satisfied based on the measurement of the reference signal;
determine that a first resource for transmission of the first report overlaps with a second resource for transmission of a second report;
determine a first priority of the first report and a second priority of the second report; and
transmit the first report on the first resource based on the first priority, the second priority, and the determination that the trigger condition is satisfied.

2. The UE of claim 1, wherein to determine the first priority of the first report and the second priority of the second report the one or more processors are configured to:
calculate a first priority metric for the first report based on a first report type of the first report; and
calculate a second priority metric for the second report based on a second report type of the second report.

3. The UE of claim 2, wherein the first report type comprises at least one of an event triggered report type, a periodic report type, a semi-periodic report type, or an aperiodic report type, and wherein the second report type comprises at least one of an event triggered report type, a periodic report type, a semi-periodic report type, or an aperiodic report type.

4. The UE of claim 1, wherein the first report comprises a first channel state information (CSI) report, and wherein the second report comprises a second CSI report.

5. The UE of claim 1, wherein the one or more processors are further configured to:
determine that the first priority is greater than the second priority; and
delay transmission of the second report based on the determination that the first priority is greater than the second priority.

6. The UE of claim 1, wherein the first report comprises an indication that transmission of the first report was triggered by satisfaction of the trigger condition.

7. The UE of claim 6, wherein the indication comprises at least one of:
a bit field of the first report; or
a scrambling sequence of a demodulation reference signal (DMRS) of the first report.

8. The UE of claim 1, wherein the one or more processors are further configured to:
determine that a size of the first report exceeds a maximum size for transmission on the first resource;
determine that a third priority of a first entry of the first report is greater than a fourth priority of a second entry of the first report; and
drop the second entry of the first report from the first report before transmitting the first report on the first resource based on the determination that the third priority of the first entry is greater than the fourth priority of the second entry.

9. The UE of claim 1, wherein the first report comprises at least one of:
a cell identifier (ID) of the candidate serving cell;
a reference signal ID of the reference signal;
a measured metric of the reference signal;
an indication of one or more beam pairs that the UE is configured to transmit and receive simultaneously; or
a sounding reference signal (SRS) port number associated with the reference signal ID of the reference signal.

10. A method, comprising:
measuring, by a user equipment (UE), a reference signal transmitted by a network node, wherein the network node is a candidate serving cell;
determining that a trigger condition for transmission of a first report is satisfied based on the measurement of the reference signal;
determining that a first resource for transmission of the first report overlaps with a second resource for transmission of a second report;
determining a first priority of the first report and a second priority of the second report; and
transmitting the first report on the first resource based on the first priority, the second priority, and the determination that the trigger condition is satisfied.

11. The method of claim 10, wherein determining the first priority of the first report and the second priority of the second report comprises:
calculating a first priority metric for the first report based on a first report type of the first report; and
calculating a second priority metric for the second report based on a second report type of the second report.

12. The method of claim 11, wherein the first report type comprises at least one of an event triggered report type, a periodic report type, a semi-periodic report type, or an aperiodic report type, and wherein the second report type comprises at least one of an event triggered report type, a periodic report type, a semi-periodic report type, or an aperiodic report type.

13. The method of claim 10, wherein the first report comprises a first channel state information (CSI) report, and wherein the second report comprises a second CSI report.

14. The method of claim 10, further comprising:
determining that the first priority is greater than the second priority; and
delaying transmission of the second report based on the determination that the first priority is greater than the second priority.

15. The method of claim 10, wherein the first report comprises an indication that transmission of the first report was triggered by satisfaction of the trigger condition.

16. The method of claim 15, wherein the indication comprises at least one of:
a bit field of the first report; or
a scrambling sequence of a demodulation reference signal (DMRS) of the first report.

17. The method of claim 10, further comprising:
determining that a size of the first report exceeds a maximum size for transmission on the first resource;
determining that a third priority of a first entry of the first report is greater than a fourth priority of a second entry of the first report; and
dropping the second entry of the first report from the first report before transmitting the first report on the first resource based on the determination that the third priority of the first entry is greater than the fourth priority of the second entry.

18. The method of claim 10, wherein the first report comprises at least one of:
a cell identifier (ID) of the candidate serving cell;
a reference signal ID of the reference signal;
a measured metric of the reference signal;
an indication of one or more beam pairs that the UE is configured to transmit and receive simultaneously; or
a sounding reference signal (SRS) port number associated with the reference signal ID of the reference signal.

19. A non-transitory computer-readable medium storing instructions that, when executed by a processor of a UE, cause the processor to perform steps comprising:
measuring a reference signal transmitted by a network node, wherein the network node is a candidate serving cell;
determining that a trigger condition for transmission of a first report is satisfied based on the measurement of the reference signal;
determining that a first resource for transmission of the first report overlaps with a second resource for transmission of a second report;
determining a first priority of the first report and a second priority of the second report; and
transmitting the first report on the first resource based on the first priority, the second priority, and the determination that the trigger condition is satisfied.

20. The non-transitory computer-readable medium of claim 19, wherein determining the first priority of the first report and the second priority of the second report comprises:
calculating a first priority metric for the first report based on a first report type of the first report; and
calculating a second priority metric for the second report based on a second report type of the second report.

21. The non-transitory computer-readable medium of claim 20, wherein the first report type comprises at least one of an event triggered report type, a periodic report type, a semi-periodic report type, or an aperiodic report type, and wherein the second report type comprises at least one of an event triggered report type, a periodic report type, a semi-periodic report type, or an aperiodic report type.

22. The non-transitory computer-readable medium of claim 19, wherein the first report comprises a first channel state information (CSI) report, and wherein the second report comprises a second CSI report.

23. The non-transitory computer-readable medium of claim 19, further storing instructions that, when executed by the processor of the UE, cause the processor to perform steps comprising:
determining that the first priority is greater than the second priority; and
delaying transmission of the second report based on the determination that the first priority is greater than the second priority.

24. The non-transitory computer-readable medium of claim 19, wherein the first report comprises an indication that transmission of the first report was triggered by satisfaction of the trigger condition.

25. The non-transitory computer-readable medium of claim 24, wherein the indication comprises at least one of:
a bit field of the first report; or
a scrambling sequence of a demodulation reference signal (DMRS) of the first report.

26. The non-transitory computer-readable medium of claim 19, further storing instructions that, when executed by the processor of the UE, cause the processor to perform steps comprising:
determining that a size of the first report exceeds a maximum size for transmission on the first resource;
determining that a third priority of a first entry of the first report is greater than a fourth priority of a second entry of the first report; and
dropping the second entry of the first report from the first report before transmitting the first report on the first resource based on the determination that the third priority of the first entry is greater than the fourth priority of the second entry.

27. The non-transitory computer-readable medium of claim 19, wherein the first report comprises at least one of:
a cell identifier (ID) of the candidate serving cell;
a reference signal ID of the reference signal;
a measured metric of the reference signal;
an indication of one or more beam pairs that the UE is configured to transmit and receive simultaneously; or
a sounding reference signal (SRS) port number associated with the reference signal ID of the reference signal.

28. A user equipment (UE), comprising:
means for measuring a reference signal transmitted by a network node, wherein the network node is a candidate serving cell;
means for determining that a trigger condition for transmission of a first report is satisfied based on the measurement of the reference signal;
means for determining that a first resource for transmission of the first report overlaps with a second resource for transmission of a second report;
means for determining a first priority of the first report and a second priority of the second report; and
means for transmitting the first report on the first resource based on the first priority, the second priority, and the determination that the trigger condition is satisfied.

29. The UE of claim 28, wherein the means for determining the first priority of the first report and the second priority of the second report comprises:
means for calculating a first priority metric for the first report based on a first report type of the first report; and
means for calculating a second priority metric for the second report based on a second report type of the second report.

30. The UE of claim 29, wherein the first report type comprises at least one of an event triggered report type, a periodic report type, a semi-periodic report type, or an aperiodic report type, and wherein the second report type comprises at least one of an event triggered report type, a periodic report type, a semi-periodic report type, or an aperiodic report type.
